(19) United States
(12) Patent Application Publication
(10) Pub. No.: US 2015/0012340 A1
(43) Pub. Date: Jan. 8, 2015

(54) METHOD OF AUTOMATED VEHICLE PARKING CONTROL

(71) Applicant: Igor Yurievich Matsur, Tula (RU)

(72) Inventor: Igor Yurievich Matsur, Tula (RU)

(21) Appl. No.: 13/979,300

(22) PCT Filed: Feb. 11, 2013
(86) PCT No.: PCT/RU2013/000095

§ 371 Date: Jul. 11, 2013

(30) Foreign Application Priority Data
Feb. 9, 2012 (RU) 2012104370

(51) Int. Cl. G06Q 20/14

(52) U.S. Cl. CPC G06Q 20/145
USPC 705/13

(57) ABSTRACT

A method of automated vehicle parking control includes detection and identification of a vehicle on a given portion of the road, and matching the traffic data thus obtained with the rules and regulations for that portion. To detect and identify a vehicle crossing the pre-set boundaries of a road portion, vehicle detection nodes probing the surrounding area using radio-frequency signals are mounted. Vehicles are with tags, allowing their identification. When a vehicle equipped with a tag enters the monitored area, the tag generates a response containing the codeword with identification data of the vehicle. The detection nodes decode the response, recording the timing of each response and calculating the average time period vehicles require to pass the given portion of the road. If a vehicle stays within the limits of the portion longer than the calculated average time period, the vehicle is considered to be parked.

### CROSS-REFERENCE TO RELATED APPLICATIONS

This application is a U.S. National Phase of PCT/RU/2013/000095, filed on Feb. 11, 2013, which claims priority to RU 2012104370, filed on Feb. 9, 2012, incorporated by reference herein in its entirety.

### BACKGROUND OF THE INVENTION

1. Field of the Invention

The present invention relates to traffic control and, in particular, to control of parking in paid parking lots.

2. Background of the Related Art

A conventional control system for parking lots with a number of parking places employs a vehicle detector connected to a billing device at each parking place, as well as a microprocessor with a timer clock. The timer clock is triggered by a signal received either from the vehicle detector or from the billing device, any of which should thus register the presence of a vehicle at a given parking place (see WO 2007/025364).

The problem of this system is that it requires each parking place to be equipped with a detector, which poses difficulties in case with large parking lots situated along the length of traffic areas. The number of detectors decreases reliability of the system, and raises its costs, all of which limit the application of this system.

Another known approach to a control system for paid parking lots has the following procedure (see RU 2271573 C1):

1. upon entering the parking place, the vehicle sends an SMS message over a GSM channel, containing:
a. vehicle identification code,
b. vehicle location code as calculated by a GNSS,
c. the code of prepayment made by the owner of the vehicle;

2. the parking system hardware receives, decodes and stores the message;

3. a check is conducted for whether the owner of the vehicle has debts to the parking system;

4. the parking time and its limits are calculated;

5. the data, together with the information about the payment balance and a possible fine for an incorrect prepayment, are then sent to the owner of the vehicle in an SMS message over the billing center of the mobile operator;

6. the parking controller uses a portable parking scanner to scan the vehicle RFID-tag positioned on the windshield;

7. the vehicle identification data is then read and compared with the data from the SMS message;

8. the parking controller feeds the parking terminal with an SMS message over a GSM channel, containing the vehicle identification data and the controller ID;

9. the terminal checks the vehicle ID against its list, calculates the parking fee, sends the vehicle, controller and payment data to the billing center;

10. the payment balance of the owner of the vehicle is then calculated and sent to the controller's parking scanner and to the owner's cell phone;

11. in case there are insufficient funds on the owner's payment balance, the controller may issue a notice or a fine, or block the passage of the vehicle if necessary;

12. upon leaving the parking lot, the owner of the vehicle sends an SMS message over a GSM channel;

13. the parking terminal stops the timer clock and feeds the mobile parking complex with an SMS message about completion of the parking.

The main disadvantage of this approach is its complexity: it requires the owner of the vehicle interact with the parking controller through SMS messages, and that, in turn, requires the efficient and uninterrupted functioning of the mobile operator. Any glitch in the mobile communication services will delay the data exchange, which can extend the time needed to park the vehicle or even prevent the execution of the entire procedure. The conventional parking system thus depends on the quality of the communication services, the quality of the power system, and the availability of a cell phone, all of which limit the application of this approach.

Another conventional solution includes the following steps (see WO/2007/008055):

1. the system takes at least one picture of an area containing at least one portion of the road, and then uses an I/O device to detect and process the number of vehicles in the picture;

2. the system builds the traffic pattern based on a movement of at least one detected vehicle;

3. the system compares the calculated speed of a number of detected vehicles with a reference speed for a portion of the road with a number of vehicles detected;

4. the system compares the calculated speed of a number of detected vehicles with a pre-set benchmark speed;

5. the system identifies the locations of detected vehicles and checks them against a map containing the information on the number of parking places;

6. the system checks the availability of parking places.

This solution can be applied to detect the vehicles parked on a given portion of the road, but its reliability is low, because it depends on data obtained from an image. Recognition of vehicles in an image is error-prone, even if it has been made by a high-resolution detector, because it is impossible to supply standard reference images of vehicles taken from every possible angle. Even a system detecting vehicles by their integral parts, such as license plates, is not reliable enough, since in traffic, esp. near the traffic lights, vehicles are so packed, that it is difficult to discern their license plates, even if the detector is positioned at some elevation. It is also difficult to analyze the image, when weather conditions deteriorate and visibility is low. These disadvantages thus limit the application of this solution.

### SUMMARY OF THE INVENTION

Accordingly, the objective of the invention is to improve reliability of detection and identification of a vehicle on a given portion of the road or a parking lot.

To achieve the objective, a method of automated vehicle parking control includes detection and identification of a vehicle on a given portion of the road, and matching the traffic data thus obtained with the rules and regulations for that portion. To detect and identify a vehicle crossing the pre-set boundaries of the given portion of the road, we suggest mounting vehicle detection nodes probing the surrounding area using radio-frequency signals. In their turn, vehicles should be equipped with nodes, or tags, allowing their identification. When a vehicle equipped with an identification tag enters the monitored area, the tag generates a response containing the codeword with identification data of the vehicle. The detection nodes receive and decode the response, recording the timing of each response and calculating the average time period vehicles require to pass the given portion of the road. In case a vehicle stays within the limits of the portion longer than the calculated average time period is, the vehicle is considered to be parking there.

In addition:
the parking time length on a given portion of the road is the time period between the vehicle entered and left the portion, as registered by the same or different detection nodes, minus the calculated average time period vehicles require to pass the portion of the road;
the identification data of the vehicle is stored in memory from the moment the vehicle is registered upon entering the portion of the road to the moment it is registered again upon leaving the portion;
the direction, in which the vehicle moves on the portion of the road, can be detected by comparing the data obtained by the detectors on the edges of the portion;
if a vehicle has been registered by one and the same detector both upon entering and upon leaving the portion of the road, then the vehicle is considered to have changed its direction or to have made a U-turn while crossing the traffic area;
the average vehicle speed for the given portion of the road is a ratio between the stretch of the portion and the average time period a vehicle requires to pass the portion;
if the number of parked vehicles exceeds a pre-set number of parking places for the given portion of the road, then a violation of parking regulation or an incident (emergency) is reported to the police, which is responsible for handling traffic jams;
a radio response is generated by the identification node, or tag, with at least one parameter of the response corresponding to the vehicle identification data;
passive or active RFID-tags are used for vehicle identification;
the average traffic rate for the given portion of the road is the number of vehicles, which have crossed the boundaries of the portion (except for the parked ones) per unit time;
the traffic density for the given portion of the road is the number of vehicles located within the boundaries of the portion (except for the parked ones) at the same time;
the average traffic dynamic clearance for the given portion of the road is a ratio between the area of the portion (except for parking places) and the average number of vehicles located within the boundaries of the portion (except for the parked ones) at the same time.

Additional features and advantages of the invention will be set forth in the description that follows, and in part will be apparent from the description, or may be learned by practice of the invention. The advantages of the invention will be realized and attained by the structure particularly pointed out in the written description and claims hereof.

It is to be understood that both the foregoing general description and the following detailed description are exemplary and explanatory and are intended to provide further explanation of the invention as claimed.

### DETAILED DESCRIPTION OF EMBODIMENTS OF THE INVENTION

Reference will now be made in detail to the embodiments of the present invention.

The method of automated vehicle parking control includes detection and identification of a vehicle on a given portion of the road, and matching the traffic data thus obtained with the rules and regulations for that portion. To detect and identify a vehicle crossing the pre-set boundaries of the given portion of the road, we suggest mounting vehicle detection nodes probing the surrounding area using radio-frequency signals. In their turn, vehicles should be equipped with nodes, or tags, allowing their identification.

When a vehicle equipped with an identification tag enters the monitored area, the tag generates a response containing the codeword with identification data of the vehicle. The detection nodes receive and decode the response, recording the timing of each response and calculating the average time period vehicles require to pass the given portion of the road. In case a vehicle stays within the limits of the portion longer than the calculated average time period is, the vehicle is considered to be parking there.

The parking time span on a given portion of the road is the time period between the vehicle entered and left the portion, as registered by one and the same or different detection nodes, minus the calculated average time period vehicles require to pass the portion.

The identification data of the vehicle is stored in memory from the moment the vehicle is registered upon entering the portion of the road to the moment it is registered again upon leaving the portion. The direction, in which the vehicle moves on the portion of the road, can be detected by comparing the data obtained by the detectors on the edges of the portion. If a vehicle has been registered by one and the same detector both upon entering and upon leaving the portion of the road, then the vehicle is considered to have changed its direction or to have made a U-turn while crossing the traffic area.

The average vehicle speed for the given portion of the road is a ratio between the stretch of the portion and the average time period a vehicle requires to pass the portion.

If the number of parked vehicles exceeds the pre-set number of parking places for the given portion of the road, then a violation of parking regulation or an incident (emergency) is reported to the traffic police, which is responsible for removing traffic jams.

A radio response is generated by the identification node, or tag, with at least one parameter of the response corresponding to the vehicle identification data, wherein passive or active RFID-tags are used for vehicle identification.

The average traffic rate for the given portion of the road is the number of vehicles, which have crossed the boundaries of the portion (except for the parked ones) in unit time.

The traffic density for the given portion of the road is the number of vehicles located within the boundaries of the portion (except for the parked ones) at the same time.

The average traffic dynamic clearance for the given portion of the road is a ratio between the area of the portion (except for parking places) and the average number of vehicles located within the boundaries of the portion (except for the parked ones) at the same time.

The method is implemented as follows:

First, a portion of the road situated in an urban or rural area is chosen for monitoring by the automated parking control system. Vehicles are to be equipped with identification nodes, or tags, which function as both receivers and transmitters, so they can receive signals generated by detection nodes and generate responses. Moreover, in order to enable identification of the vehicle by a detection node, the transmitter on the vehicle should be able to include an identifying codeword into the response generated.

Detection nodes are to be placed on the edges of the given portion of the road containing a parking lot or a number of parking places. The distance between the edges, or boundaries, depends on the size of the portion, which can vary from 100 m to 1 km and more. Detection nodes can be mounted on posts, at farms, utility poles or under the roadway.

When a vehicle crosses an edge of the portion of the road and enters the portion, it is probed by a detection node placed on that edge, and the identification tag of the vehicle generates a response containing a codeword with vehicle identification data, which is received by the detection node and stored in memory of parking control devices. When the vehicle crosses the same edge of the portion or another one and leaves, it is detected and identified again. As a result, the system registers all the vehicles entering and leaving the boundaries of the given portion of the road.

Simultaneous detection and identification of vehicles provides for their reliable and precise registration, as well as calculation of time they spend to pass the portion.

Vehicles can pass the given portion of the road without stopping (parking), in which case the time they spend will be equal to the average time period vehicles require to pass the portion. This average value is based on the analysis of the movement of vehicles passing the portion without stopping (parking), and is calculated either continuously during the whole day or periodically, e.g. once per hour. In case a vehicle stays within the limits of the portion longer than the calculated average time period is, the vehicle is considered to be parking there.

A vehicle is considered to be parking, and the timer clock is triggered, if the time period between the vehicle being detected by detection nodes on the edges of the portion of the road is longer than the average time period vehicles require to pass the portion. Until it leaves the portion, the timer clock counts the time of parking. After the vehicle leaves, the timer clock stops, and the parking control system calculates the parking cost, if necessary. A bill is then sent to the owner of the vehicle at their address, registered in the vehicle owners' database, or the needed sum is drawn automatically from the owner's account linked to the vehicle identification data provided by the identification tag of the vehicle.

A vehicle is considered to be parking either upon entering the portion of the road or upon triggering the timer clock. The clock stops, when the vehicle is detected again on either of the boundaries of the portion. The parking time is then modified according to the average time period required to pass the portion.

A vehicle can cross the portion of the road in either direction, park there for some time and/or turn around and leave the portion. In the latter case, it will be detected both upon entering and upon leaving the portion by one and the same detection node.

### EXAMPLE

A vehicle approaches a pre-set portion of the road situated in the town center and crosses one of its boundaries. Under the roadway, there is a detection node emitting signals in the direction of the vehicle. The main lobe of the detection node is turned upwards, its width is about 180°, and the range of its signal is approximately 1 m. When a vehicle's identification tag gets into the range, it generates a response containing necessary identification data.

This response should also contain a unique codeword, so that no error is made when multiple responses from a number of vehicles are registered by side lobes of detector nodes. The same vehicle is registered only once, regardless of the number of responses received by a detector node.

Probing the area with vehicle detectors provides for complete and reliable identification of all vehicles crossing the boundaries of a given portion of the road, regardless of time of the day, seasons, weather and lighting conditions, thus increasing reliability of the system.

Vehicle identification data are stored in memory of parking control devices from the moment the vehicle enters the portion of the road till the moment it leaves. The vehicle is considered to have left the portion, if its identification data received by a detection node on the edge of the portion matches the already stored data.

Vehicles can pass the given portion of the road without stopping (parking), in which case the time they spend will be equal to the average time period vehicles require to pass the portion.

The average time period required to pass the given portion of the road is based on the analysis of the movement of vehicles passing the portion without stopping (parking) and depends on the length of the portion, its speed limit, traffic situation, the number of vehicles, weather conditions, etc. and thus can vary.

In case a vehicle stays within the limits of the portion longer than the calculated average time period is, the vehicle is considered to be parking there.

If the vehicle is considered to be parking, the timer clock triggered counts the parking time. This time is then compared to the pre-set time limit for the given portion of the road. In case the parking limit is broken, a fine is issued and sent to the owner of the vehicle at their address, registered in the vehicle owners database, or the needed sum is drawn automatically from the owner's account linked to the vehicle identification data provided by the identification tag of the vehicle.

In case there is a paid parking lot on the given portion of the road, the parking time is measured against a set rate. After the parking is over, a bill is issued and sent to the owner of the vehicle at their address, registered in the vehicle owners database, or the needed sum is drawn automatically from the owner's account linked to the vehicle identification data provided by the identification tag of the vehicle.

The system calculates the average traffic rate for the given portion of the road, which is the number of vehicles, which have crossed the boundaries of the portion (except for the parked ones) in unit time.

The system calculates the traffic density for the given portion of the road, which is the number of vehicles located within the boundaries of the portion (except for the parked ones) at the same time;

The system calculates the average traffic dynamic clearance for the given portion of the road, which is a ratio between the area of the portion (except for parking places) and the average number of vehicles located within the boundaries of the portion (except for the parked ones) at the same time.

All nodes and tags described in the present invention can be produced on the basis of existing standard components and stock devices.

Therefore, the present method has much wider application if compared to the conventional ones, since it increases reliability of vehicle detection and identification.

Having thus described the different embodiments of a system and method, it should be apparent to those skilled in the art that certain advantages of the described method and apparatus have been achieved. In particular, it should be appreciated by those skilled in the art that the proposed method provides for safe and efficient downloading of server applications to a mobile device.

It should also be appreciated that various modifications, adaptations, and alternative embodiments thereof may be made within the scope and spirit of the present invention. The invention is further defined by the following claims.

What is claimed is:

1. A method of automated vehicle parking control, comprising:
using radio-frequency signals, detection and identification of a vehicle on a portion of a road when the vehicle crosses boundaries of the portion by receiving a response including a codeword with vehicle identification data from an RF tag mounted on the vehicle;
matching the traffic data thus obtained with the rules and regulations for the portion;
recording a timing of each response and calculating an average time period vehicles require to pass the portion,
wherein, when the vehicle stays within the portion longer than the calculated average time period, the vehicle is considered to be parking on the portion;
fixing a parking time span on the portion for the automatic billing as a time period between the vehicle entering and leaving the portion, minus the calculated average time period;
storing the identification data of the vehicle from the moment the vehicle is registered upon entering the portion to the moment it leaves the portion, and
automatically billing a driver of the vehicle for parking.

2. The method of claim 1, wherein a direction in which the vehicle moves on the portion is detected by comparing data obtained by detectors located on the edges of the portion.

3. The method of claim 4, wherein when a vehicle is registered by the same detector both upon entering and leaving the portion, then the vehicle is considered to have changed its direction or to have made a U-turn.

4. The method of claim 1, wherein when the number of parked vehicles exceeds the pre-set number of parking places for the portion, then a violation of parking regulation or a traffic incident is reported.

5. The method of claim 1, wherein a radio response is generated by the tag on the vehicle with at least one parameter of the response corresponding to the vehicle identification data.

6. The method of claim 1, wherein the tags are passive RFID tags.

7. The method of claim 1, wherein the tags are active RFID tags.
